(19) United States
(12) Patent Application Publication
(10) Pub. No.: US 2006/0061722 A1
(43) Pub. Date: Mar. 23, 2006

(54) Liquid crystal display and panel therefor

(75) Inventor: Sahng-Ik Jun, Seoul (KR)

Correspondence Address: F. CHAU & ASSOCIATES, LLC, 130 WOODBURY ROAD, WOODBURY, NY, 11797, US

(73) Assignee: Samsung Electronics CO., LTD., Suwon-si (KR)

(21) Appl. No.: 11/229,777

(22) Filed: Sep. 19, 2005

(30) Foreign Application Priority Data
Sep. 17, 2004 (KR) 10-2004-0074593

(51) Int. Cl. G02F 1/1343

(52) U.S. Cl. 349/139

(57) ABSTRACT

A liquid crystal display includes a first substrate; a pixel electrode disposed on the first substrate and having a first cutout extending at an oblique angle to a perimeter edge of the pixel electrode, a second substrate facing the first substrate, a common electrode disposed on the second substrate and having a second cutout arranged adjacent to the first cutout, an opaque member disposed on one of the first or the second substrates, and a liquid crystal layer disposed between the pixel electrode and the common electrode, wherein the first cutout divides the pixel electrode into partitions, wherein the partitions are connected to each other by an interconnection, and the interconnection is spaced apart from the perimeter edge of the pixel electrode or disposed on or under the opaque member.

This application claims priority to Korean Patent Application No. 10-2004-0074593 filed 17 Sep. 2004 in the Korean Intellectual Property Office (KIPO).

### BACKGROUND OF THE INVENTION

(a) Field of the Invention

The present invention relates to a liquid crystal display and a panel therefor.

(b) Description of Related Art

Liquid crystal displays (LCDs) are among the most widely used flat panel displays. An LCD includes two panels provided with field-generating electrodes such as pixel electrodes and a common electrode, and a liquid crystal (LC) layer interposed therebetween. The LCD displays images by applying voltages to the field-generating electrodes to generate an electric field in the LC layer, which controls an orientation of LC molecules in the LC layer to adjust a polarization of incident light.

The LCD further includes a plurality of switching elements connected to the pixel electrodes and a plurality of signal lines, such as gate lines and data lines, for controlling the switching elements to apply voltages to the pixel electrodes.

Among different types of LCDs, a vertical alignment (VA) mode LCD, which aligns (e.g., tilts) LC molecules such that the long axes of the LC molecules are perpendicular to the panels in the absence of an electric field, achieves a high contrast ratio and a wide reference-viewing angle.

The reference-viewing angle of the VA mode LCD depends upon the arrangement of cutouts in the field-generating electrodes and protrusions on the field-generating electrodes. The cutouts and the protrusions can determine the tilt of the LC molecules. The reference-viewing angle can be widened by appropriately arranging cutouts and protrusions to vary the tilt of the LC molecules.

Electric fields generated between the data lines and the pixel electrodes and between the data lines and the common electrode may disturb the tilt of the LC molecules disposed near edges of the pixel electrodes, thereby increasing a response time of the LC layer.

In addition, the pixel electrodes can be short-circuited with other conductors.

Therefore, a need exists for a circuit layout of a liquid crystal display designed so that a short circuit is substantially prevented and in a case where a short circuit has occurred, is easily removed.

### SUMMARY OF THE INVENTION

A liquid crystal display panel according to an embodiment of the present invention includes a substrate, and a pixel electrode disposed on the substrate, the pixel electrode having a plurality of cutouts extending at one or more oblique angles to a perimeter edge of the pixel electrode, wherein the cutouts divide the pixel electrode into a plurality of partitions, wherein the partitions are connected to each other by a respective one of a plurality of interconnections, and the plurality of interconnections are spaced apart from the perimeter edge of the pixel electrode.

The liquid crystal display panel may further include a thin film transistor coupled to the pixel electrode, a gate line coupled to the thin film transistor, and a data line coupled to the thin film transistor.

The liquid crystal display panel may further include an insulating layer disposed on the thin film transistor, the gate line, and the data line and disposed under the pixel electrode, and a shielding electrode disposed on the insulating layer, overlapping the data line, and spaced apart from the pixel electrode. The insulating layer comprises an organic material.

A liquid crystal display panel according to an embodiment of the present invention includes a substrate, an opaque member disposed on the substrate, and a pixel electrode disposed on the substrate, insulated from the opaque member, overlapping the opaque member, and having a cutout that extends at an oblique angle to a perimeter edge of the pixel electrode, wherein the cutout divides the pixel electrode into a plurality of partitions, the plurality of partitions are connected to each other by an interconnection, and the interconnection is disposed substantially on a perimeter edge of the pixel electrode, proximate to the opaque member.

The liquid crystal display panel may further include a thin film transistor including a drain electrode coupled to the pixel electrode, a gate line coupled to the thin film transistor, and a data line coupled to the thin film transistor.

The opaque member may include at least one of a portion of the gate line and/or a portion of the drain electrode, or a storage electrode overlapping the drain electrode.

The liquid crystal display panel may further include an insulating layer disposed on the opaque members and the data line and disposed under the pixel electrode, and a shielding electrode disposed on the insulating layer, overlapping the data line, and spaced apart from the pixel electrode. The insulating layer may include an organic material.

A liquid crystal display panel according to another embodiment of the present invention includes a substrate; a thin film transistor disposed on the substrate, a gate line coupled to the thin film transistor, a data line coupled to the thin film transistor, an insulating layer disposed on the thin film transistor, the gate line, and the data line, a pixel electrode disposed on the insulating layer and coupled to the thin film transistor, and a shielding electrode disposed on the insulating layer, overlapping the data line, and spaced apart from the pixel electrode by a distance equal to or greater than about seven microns.

The insulating layer may include organic material.

The pixel electrode may have a plurality of cutouts.

The pixel electrode may include a plurality of first cutouts extending oblique to an edge of the pixel electrode, and the liquid crystal display may further include a shielding electrode disposed on the insulating layer, overlapping the data line, and spaced apart from the pixel electrode by a distance equal to or greater than about seven microns, a second substrate facing the first substrate, and a common electrode disposed on the second substrate and having a plurality of second cutouts arranged alternately between the first cutouts, wherein at least one of the second cutouts has a first portion substantially parallel to the first cutouts and a second portion connected to the first portion and making an obtuse angle with the first portion, the second portion having a first edge overlapping the pixel electrode and a second edge disposed opposite the first edge with respect to a perimeter edge of the pixel electrode, and the distance between the first edge of the second portion and the perimeter edge of the pixel electrode is equal to from about five microns to about seven microns.

A liquid crystal display according to an embodiment of the present invention includes a first substrate, a pixel electrode disposed on the first substrate, the pixel electrode having a first cutout extending at an oblique angle to a perimeter edge of the pixel electrode, a second substrate facing the first substrate; a common electrode disposed on the second substrate and having a second cutout arranged adjacent to the first cutout, an opaque member disposed on one of the first or the second substrates, and a liquid crystal layer disposed between the pixel electrode and the common electrode, wherein the first cutout divides the pixel electrode into a plurality of partitions, the plurality of partitions are connected to each other by an interconnection, and the interconnection is spaced apart from the perimeter edge of the pixel electrode or disposed on or under the opaque member.

The liquid crystal display may further include a thin film transistor including a drain electrode coupled to the pixel electrode, a gate line coupled to the thin film transistor, a data line coupled to the thin film transistor, and a storage electrode overlapping the drain electrode.

The opaque member may include at least one of a portion of the gate line, a portion of the drain electrode, and a portion of the storage electrode, or a light blocking member disposed around the pixel electrode.

The liquid crystal display panel may further include an insulating layer disposed on the thin film transistor, the gate line, the data line, and the storage electrode, and disposed under the pixel electrode, and a shielding electrode disposed on the insulating layer, overlapping the data line, and spaced apart from the pixel electrode.

The drain electrode may extend along one of the first or the second cutouts.

The second cutout may have a first portion substantially parallel to the first cutout and a second portion connected to the first portion and making an obtuse angle greater than about 135 degrees with the first portion, and the second portion may have a first edge overlapping the pixel electrode and a second edge disposed opposite the first edge with respect to an edge of the pixel electrode.

### BRIEF DESCRIPTION OF THE DRAWINGS

The present invention will become more apparent by describing embodiments thereof in detail with reference to the accompanying drawing in which:

FIG. 1 is a layout view of a TFT array panel for an LCD according to an embodiment of the present invention;

FIG. 2 is a layout view of a common electrode panel for an LCD according to an embodiment of the present invention;

FIG. 3 is a layout view of an LCD including the TFT array panel shown in FIG. 1 and the common electrode panel shown in FIG. 2;

FIGS. 4 and 5 are sectional views of the LCD shown in FIG. 3 taken along lines IV-IV and V-V;

FIG. 6 is a layout view of an LCD according to another embodiment of the present invention;

FIG. 7 is a sectional view of the LCD shown in FIG. 6 taken along line VII-VII′;

FIG. 8 is an expanded view of a portion of the LCD shown in FIG. 6 and

FIGS. 9 and 10 are layout views of LCDs according to other embodiments of the present invention.

### DETAILED DESCRIPTION OF PREFERRED EMBODIMENTS

The present invention now will be described more fully hereinafter with reference to the accompanying drawings, in which preferred embodiments of the invention are shown. This invention may, however, be embodied in many different forms and should not be construed as limited to embodiments set forth herein. Like numerals refer to like elements throughout.

In the drawings, the thickness of layers and regions are exaggerated for clarity. Like numerals refer to like elements throughout It will be understood that when an element such as a layer, region or substrate is referred to as being “on” another element, it can be directly on the other element or intervening elements may also be present. In contrast, when an element is referred to as being “directly on” another element, there are no intervening elements present.

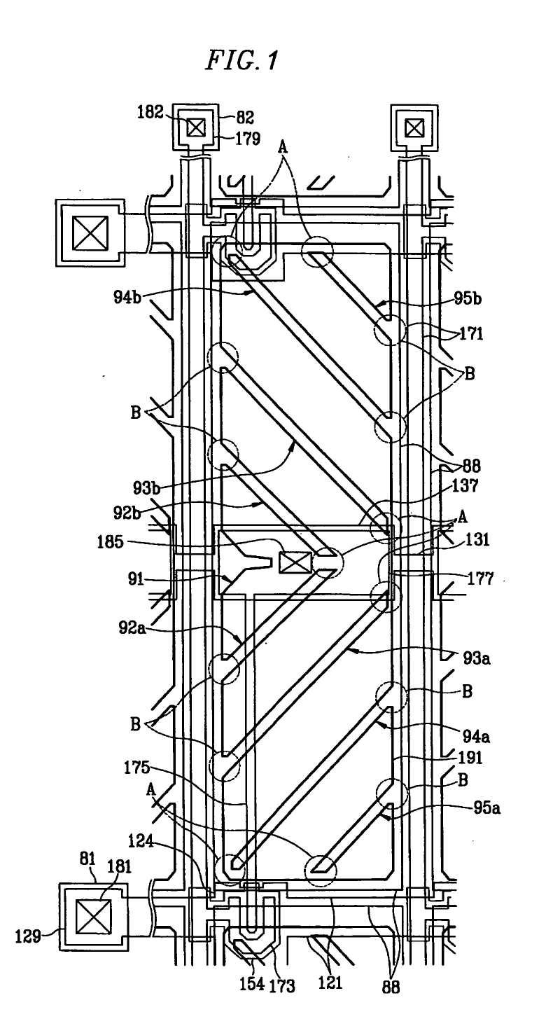

An LCD according to an embodiment of the present invention will be described in detail with reference to FIGS. 1, 2, 3 and 4.

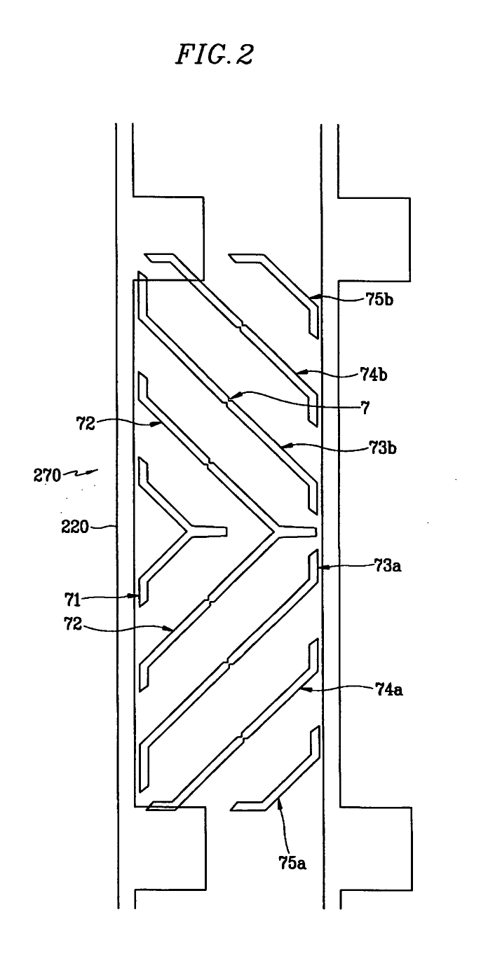

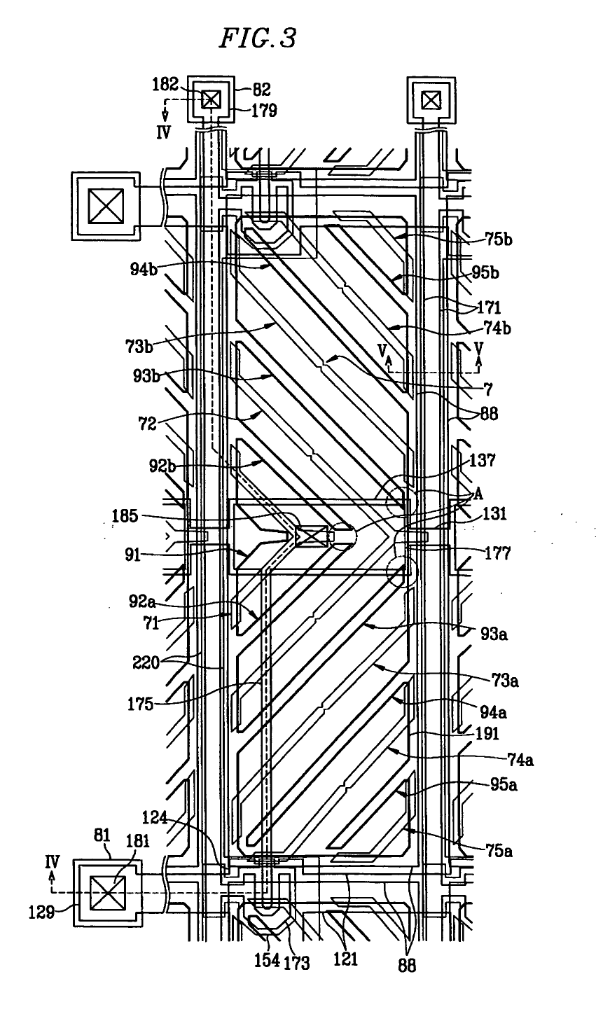

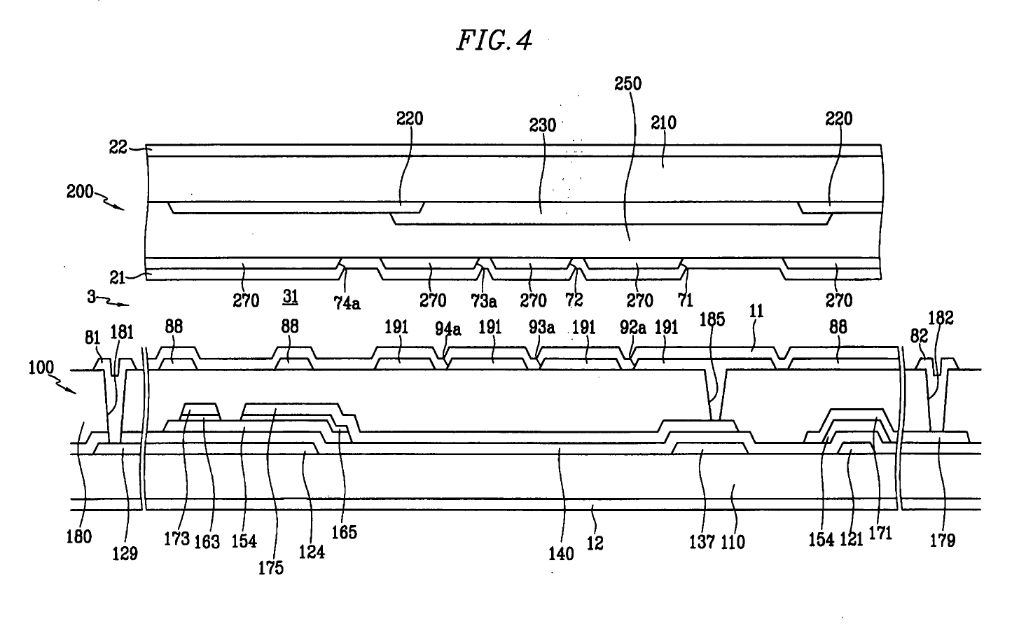

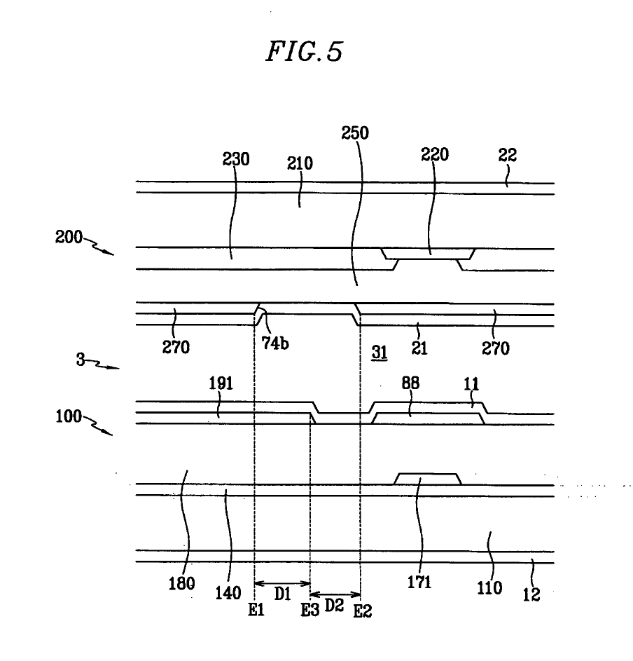

FIG. 1 is a layout view of a thin film transistor (TFT) array panel for an LCD according to an embodiment of the present invention, FIG. 2 is a layout view of a common electrode panel for an LCD according to an embodiment of the present invention, FIG. 3 is a layout view of an LCD including the TFT array panel shown in FIG. 1 and the common electrode panel shown in FIG. 2, and FIGS. 4 and 5 are sectional views of the LCD shown in FIG. 3 taken along lines IV-IV and V-V, respectively.

Referring to FIGS. 4 and 5, an LCD according to an embodiment of the present invention includes a TFT array panel 100, a common electrode panel 200 facing the TFT array panel 100, and a liquid crystal layer 3 interposed between the panels 100 and 200.

The TFT array panel 100 will be described with reference to FIGS. 1 and 3-5.

A plurality of gate lines 121 and a plurality of storage electrode lines 131 are formed on an insulating substrate 110 such as transparent glass or plastic.

The gate lines 121 transmit gate signals and extend substantially in a transverse direction on the substrate. Each of the gate lines 121 includes a plurality of gate electrodes 124 projecting upward and an end portion 129 having an area for contact with another layer or an external driving circuit. A gate driving circuit (not shown) for generating the gate signals may be mounted on a flexible printed circuit (FPC) film (not shown), which may be coupled to the substrate 110, directly mounted on the substrate 110, or integrated onto the substrate 110. The gate lines 121 may be connected to a driving circuit that may be integrated on the substrate 110.

The storage electrode lines 131 are supplied with a predetermined voltage and extend substantially parallel to the gate lines 121. Each of the storage electrode lines 131 is disposed between two gate lines 121 and is substantially equidistant from the two gate lines 121. Each of the storage electrode lines 131 includes a plurality of storage electrodes 137 extend upward and/or downward. The storage electrode lines 131 may have various shapes and arrangements.

The gate lines 121 and the storage electrode lines 131 are preferably made of an aluminum (Al) containing metal such as Al and Al alloy, silver (Ag) containing metal such as Ag and Ag alloy, copper (Cu) containing metal such as Cu and Cu alloy, molybdenum (Mo) containing metal such as Mo and Mo alloy, chromium (Cr), tantalum (Ta), or titanium (Ti). The gate lines 121 may have a multi-layered structure including two conductive films (not shown) having different physical characteristics. One of the two films is preferably made of low resistivity metal including an Al containing metal, a Ag containing metal, or a Cu containing metal. Such a film can reduce a signal delay or voltage drop. The other film is preferably made of material such as a Mo containing metal, Cr, Ta, or Ti. Such a film has desirable physical, chemical, and electrical contact characteristics with other materials such as indium tin oxide (ITO) or indium zinc oxide (IZO). Examples of the multi-layer structure include a lower Cr film and an upper Al (alloy) film and a lower Al (alloy) film and an upper Mo (alloy) film. The gate lines 121 and the storage electrode lines 131 may be made of various metals or conductors.

Lateral sides of the gate lines 121 and the storage electrode lines 131 are inclined relative to a surface of the substrate 110, and an inclination angle thereof ranges about 30-80 degrees.

A gate insulating layer 140, preferably made of silicon nitride (SiNx) or silicon oxide (SiOx), is formed on the gate lines 121 and the storage electrode lines 131.

A plurality of semiconductor islands 154, preferably made of hydrogenated amorphous silicon (abbreviated to “a-Si”) or polysilicon, are formed on the gate insulating layer 140. Each of the semiconductor islands 154 is disposed on the gate electrodes 124 and on the gate lines 121. The semiconductor islands 154 disposed on the gate lines 121 include extensions covering edges of gate lines 121.

A plurality of pairs of ohmic contact islands 163 and 165 are formed on the semiconductor islands 154. The ohmic contacts 163 and 165 are preferably made of n+ hydrogenated a-Si, heavily doped with an n-type impurity such as phosphorous or they may be made of silicide.

The lateral sides of the semiconductor islands 154 and the ohmic contacts 163 and 165 are inclined relative to the surface of the substrate 110, and the inclination angles thereof are preferably in a range of about 30-80 degrees.

A plurality of data lines 171 and a plurality of drain electrodes 175 are formed on the ohmic contacts 163 and 165 and the gate insulating layer 140.

The data lines 171 transmit data signals and extend substantially in a longitudinal direction to intersect the gate lines 121 and the storage electrode lines 131. Each data line 171 includes a plurality of source electrodes 173 projecting toward the gate electrodes 124 and curved like a character U and an end portion 179 having an area for contact with another layer or an external driving circuit. A data driving circuit (not shown) for generating the data signals may be mounted on a FPC film (not shown), which may be coupled to the substrate 110, directly mounted on the substrate 110, or integrated onto the substrate 110. The data lines 171 may extend to be connected to a driving circuit that may be integrated on the substrate 110.

The drain electrodes 175 are separated from the data lines 171 and disposed opposite the source electrodes 173 with respect to the gate electrodes 124. Each of the drain electrodes 175 includes a wide portion 177 and a linear portion. The wide portion 177 overlaps a storage electrode 137 and an end of the linear portion is partly surrounded by a source electrode 173.

A gate electrode 124, a source electrode 173, and a drain electrode 175 along with a semiconductor island 154 form a TFT having an electric channel formed in the semiconductor island 154 disposed between the source electrode 173 and the drain electrode 175.

The data lines 171 and the drain electrodes 175 are preferably made of a refractory metal such as Cr, Mo, Ta, Ti, or alloys thereof. The data lines 171 and the drain electrodes 175 may have a multilayered structure including a refractory metal film (not shown) and a low resistivity film (not shown). Examples of the multi-layered structure are a double-layered structure including a lower Cr/Mo (alloy) film and an upper Al (alloy) film and a triple-layered structure of a lower Mo (alloy) film, an intermediate Al (alloy) film, and an upper Mo (alloy) film. The data lines 171 and the drain electrodes 175 may be made of various metals or conductors.

The data lines 171 and the drain electrodes 175 have inclined edge profiles, and the inclination angles thereof range between about 30-80 degrees.

The ohmic contacts 163 and 165 are interposed only between the underlying semiconductor islands 154 and the overlying conductors 171 and 175 thereon and reduce a contact resistance therebetween. Extensions of the semiconductor islands 154 disposed on the gate lines 121 smooth the profile of the surface, thereby substantially preventing a disconnection of the data lines 171. The semiconductor islands 154 include exposed portions, which are not covered with the data lines 171 and the drain electrodes 175, such as portions located between the source electrodes 173 and the drain electrodes 175.

A passivation layer 180 is formed on the data lines 171, the drain electrodes 175, and the exposed portions of the semiconductor islands 154. The passivation layer 180 is preferably made of an organic insulator, such as acrylic resin, and may have a flat top surface. The organic insulator may be photosensitive and have a dielectric constant of less than about 4.0. The passivation layer 180 may further include an inorganic insulator, such as silicon nitride or silicon oxide, disposed under the organic insulator. Such a passivation layer 180 includes the insulating characteristics of the organic insulator while substantially preventing the exposed portions of the semiconductor islands 154 from being damaged by the organic insulator. The passivation layer 180 may only include inorganic insulator or may be substituted with color filters.

The passivation layer 180 has a plurality of contact holes 182 and 185 exposing the end portions 179 of the data lines 171 and the wide portions 177 of the drain electrodes 175, respectively. The passivation layer 180 and the gate insulating layer 140 have a plurality of contact holes 181 exposing the end portions 129 of the gate lines 121.

A plurality of pixel electrodes 191, a shield electrode 88, and a plurality of contact assistants 81 and 82 are formed on the passivation layer 180. They are preferably made of a transparent conductor such as ITO or IZO or a reflective conductor such as Ag, Al, Cr, or alloys thereof.

The pixel electrodes 191 are physically and electrically connected to the drain electrodes 175 through the contact holes 185 such that the pixel electrodes 191 receive data voltages from the drain electrodes 175. The pixel electrodes 191 supplied with the data voltages generate electric fields in cooperation with a common electrode 270 of the common electrode panel 200 supplied with a common voltage, which control the orientation of liquid crystal molecules 31 of the liquid crystal layer 3 disposed between the two electrodes 191 and 270. A pixel electrode 191 and the common electrode 270 form a capacitor, and more particularly a liquid crystal capacitor, which stores applied voltages after the TFT turns off.

A pixel electrode 191 and a wide portion 177 of a drain electrode 175 connected thereto overlap a storage electrode line 131 including storage electrodes 137. The pixel electrode 191 and a drain electrode 175 connected thereto and the storage electrode line 131 form an additional capacitor, and more particularly a storage capacitor, which enhances the voltage storing capacity of the liquid crystal capacitor.

Each pixel electrode 191 is approximately a rectangle that has four edges defining a perimeter, including lower, upper, left, and right edges substantially parallel to the gate lines 121 or the data lines 171. Comers of the perimeter edges are chamfered. The upper edge of the pixel electrode 191 overlaps an upper gate line 121 adjacent to the pixel electrode 191, while the lower edge of the pixel electrode 191 is spaced apart from a lower gate line 121 adjacent to the pixel electrode 191. The lower gate line 121 is electrically coupled to the pixel electrode 191 through a TFT. The left and right (e.g., longitudinal) edges of the pixel electrode 191 are spaced apart from the data lines 171 adjacent to the pixel electrode 191. The chamfered edges of the pixel electrode 191 make an angle of about 45 degrees.

Each pixel electrode 191 has a center cutout 91, a plurality of lower cutouts 92a, 93a, 94a and 95a, and a plurality of upper cutouts 92b, 93b, 94b and 95b, which divide the pixel electrode 191 into a plurality of partitions. The cutouts 91-95b substantially have inversion symmetry across the storage electrode line 131.

The lower and the upper cutouts 92a-95b are disposed at lower and upper halves of the pixel electrode 191, respectively, which can be divided by the storage electrode line 131. The lower and the upper cutouts 92a-95b are disposed at an angle of about 45 degrees to the gate lines 121. The lower cutouts 92a-95a extend substantially perpendicular to the upper cutouts 92b-95b.

The lower and the upper cutouts 92a and 92b obliquely extend from a left edge of the pixel electrode 191 approximately to a center of a storage electrode 137. Although the cutouts 92a and 92b approach each other, they do not meet each other.

The lower and the upper cutouts 93a and 93b obliquely extend from the left edge of the pixel electrode 191 approximately to edges of the storage electrode 137 and to a right edge of the pixel electrode 191 without meeting the right edge.

The lower and the upper cutouts 94a and 94b obliquely extend from the right edge of the pixel electrode 191 approximately to left comers of the pixel electrode 191 without meeting the left comers.

The lower and the upper cutouts 95a and 95b obliquely extend from the right edge of the pixel electrode 191 approximately to the lower and the upper edge of the pixel electrode 191, respectively, without meeting the lower and the upper edges.

The center cutout 91 extends along the storage electrode line 131 and has an inlet from the left edge of the pixel electrode 191, which has a pair of inclined edges substantially parallel to the lower cutouts 92a-95a and the upper cutout 92b-95b, respectively.

Accordingly, the lower half of the pixel electrode 191 is partitioned into five lower partitions by the lower cutouts 92a-95a and the upper half of the pixel electrode 191 is partitioned into five upper partitions by the upper cutout 92b-95b.

In view of the partitions, the partitions divided by the cutouts 91-95b are connected to each other by interconnections, enclosed by dotted circles and reference numeral A in FIG. 1. A plurality of the interconnections are disposed on or disposed near opaque members such as the storage electrodes 137 and the gate lines 121. The acute vertices of the partitions that are not connected to the interconnections are chamfered.

The number of partitions or the number of the cutouts is varied depending on design factors such as the size of pixels, the ratio of the transverse edges to the longitudinal edges of the pixel electrode 191, the type and characteristics of the liquid crystal layer 3, etc.

The shielding electrode 88 is supplied with a common voltage and includes longitudinal portions extending along the data lines 171 and transverse portions extending along the gate lines 127. The longitudinal portions fully cover the data lines 171 such that the shielding electrode 88 blocks electric fields between the data lines 171 and the pixel electrodes 191 and between the data lines 171 and the common electrode 270. Such a shielding electrode 88 can reduce a distortion of the voltage of the pixel electrode 191 and the signal delay of the data voltages transmitted by the data lines 171. In addition, the transverse portions of the shielding electrode 88 connecting adjacent longitudinal portions overlap upper edges of the gate lines 121. Such a shielding electrode 88 can reduce a parasitic capacitance between the gate lines 121 and the pixel electrodes 191 electrically coupled to the gate lines 121 through the TFTs, thereby reducing flickering and afterimages.

The shielding electrode 88 is spaced apart from the pixel electrodes 191 to substantially prevent a short circuit between the shielding electrode 88 and the pixel electrode 191. A distance between the pixel electrodes 191 and the data lines 171 may be increased to reduce the parasitic capacitance therebetween.

No interconnection between the partitions of the pixel electrodes 191 is adjacent to the longitudinal portions of the shielding electrodes 88. This configuration reduces the probability of a short circuit between the shielding electrode 88 and the pixel electrodes 191.

As the distance between the shielding electrode 88 and the pixel electrodes 191 increases, an aperture ratio decreases. The distance between the shielding electrode 88 and the pixel electrodes 191 is preferably determined in consideration of both the aperture ratio and a probability of a short circuit. The distance between the shielding electrode 88 and the pixel electrodes 191 for substantially preventing a short circuit is preferably larger than a resolution of an exposer used in a lithography step for forming the shielding electrode 88 and a repairable size of a particle that causes a short circuit. The term “repairable” means that the particle can be detected and repaired by available repairing equipment. For example, the distance may be equal to or greater than about six microns or seven microns.

It is preferable that, for repairing a short circuit by means of laser cutting, etc., no conductive member crosses over an area between the shielding electrode 88 and the pixel electrodes 191.

The contact assistants 81 and 82 are connected to the end portions 129 of the gate lines 121 and the end portions 179 of the data lines 171 through the contact holes 181 and 182, respectively. The contact assistants 81 and 82 protect the end portions 129 and 179 and enhance an adhesion between the end portions 129 and 179 and external devices.

The description of the common electrode panel 200 follows with reference to FIGS. 2-5.

A light blocking member 220, referred to as a black matrix, for preventing light leakage is formed on an insulating substrate 210 such as transparent glass or plastic. The light blocking member 220 includes a plurality of rectilinear portions facing the data lines 171 on the TFT array panel 100 and a plurality of widened portions facing the TFTs on the TFT array panel 100. The rectilinear portions have a width less than the data lines 171 such that an aperture ratio is increased. Alternatively, the light blocking member 220 may have a plurality of openings that face the pixel electrode 191, the light blocking member 220 having substantially the same planar shape as the pixel electrode 191. In addition, the light blocking member 220 may cover the interconnections at the lower edges of the pixel electrodes 191.

A plurality of color filters 230 are also formed on the substrate 210, disposed substantially in the areas between the light blocking member 220. The color filters 230 may extend substantially in the longitudinal direction along the pixel electrodes 191. The color filters 230 may represent one of the primary colors such as red, green or blue.

An overcoat 250 is formed on a surface of the color filters 230 and the light blocking member 220 facing the TFT array panel 100. The overcoat 250 is preferably made of (organic) insulator and substantially prevents the color filters 230 from being exposed and provides a flat surface. The overcoat 250 may be omitted.

A common electrode 270 is formed on a surface the overcoat 250 facing the TFT array panel 100. The common electrode 270 is preferably made of a transparent conductive material such as ITO and IZO and has a plurality of sets of cutouts 71, 72, 73a, 73b, 74a, 74b, 75a and 75b.

A set of cutouts 71-75b face a pixel electrode 191 and include center cutouts 71 and 72, lower cutouts 73a, 74a and 75a and upper cutouts 73b, 74b and 75b. Each of the cutouts 71-75b is disposed between adjacent cutouts 91-95b of the pixel electrode 191 or between a cutout 95a or 95b and a chamfered edge of the pixel electrode 191. In addition, each of the cutouts 71-75b has at least an oblique portion extending substantially parallel to the lower cutout 93a-95a or the upper cutout 93b-95b of the pixel electrode 191. Each of the oblique portions of the cutouts 72-74b has a depressed notch 7. The cutouts 71-75b substantially have inversion symmetry across the storage electrode line 131.

Each of the lower and the upper cutouts 73a-75b includes an oblique portion, a transverse portion and a longitudinal portion or an oblique portion and a pair of longitudinal portions. The oblique portion extends approximately from a left edge, a left corner, a lower edge, or an upper edge of the pixel electrode 191 approximately to a right edge of the pixel electrode 191. The transverse and longitudinal portions extend from respective ends of the oblique portion along edges of the pixel electrode 191, overlapping the edges of the pixel electrode 191, and making obtuse angles with the oblique portion.

Each of the center cutouts 71 and 72 includes a central transverse portion, a pair of oblique portions, and a pair of terminal longitudinal portions. The central transverse portion extends approximately from a center or the right edge of the pixel electrode 191 along the storage electrode line 131. The oblique portions extend from an end of the central transverse portion approximately to the left edge of the pixel electrode, making oblique angles with the central transverse portion. The terminal longitudinal portions extend from the ends of the respective oblique portions along the left edge of the pixel electrode 191, overlapping the left edge of the pixel electrode 191, and making obtuse angles with the respective oblique portions.

The number of the cutouts 71-75b may be also varied depending on the design factors. The light blocking member 220 may overlap the cutouts 71-75b to block the light leakage through the cutouts 71-75b.

Alignment layers 11 and 21, which may be homeotropic, are coated on inner surfaces of the panels 100 and 200, and polarizers 12 and 22 are provided on outer surfaces of the panels 100 and 200 having crossed polarization axes, wherein one of the polarization axes may be parallel to the gate lines 121. One of the polarizers 12 and 22 may be omitted when the LCD is a reflective LCD.

The LCD may further include at least one retardation film (not shown) for compensating a retardation of the LC layer 3. The LCD may further include a backlight unit (not shown) supplying light to the LC layer 3 through the polarizers 12 and 22, the retardation film, and the panels 100 and 200.

It is preferable that the LC layer 3 has negative dielectric anisotropy and is subjected to a vertical alignment, wherein the LC molecules 31 in the LC layer 3 are aligned such that their long axes are substantially vertical to the surfaces of the panels 100 and 200 in the absence of an electric field. Accordingly, incident light cannot pass the crossed polarization system 12 and 22.

Upon application of the common voltage to the common electrode 270 and a data voltage to the pixel electrode 191, an electric field is generated substantially perpendicular to the surfaces of the panels 100 and 200. The pixel electrode 191 and the common electrode 270 are commonly referred to as “field generating electrodes” hereinafter. The LC molecules 31 tend to change their orientations in response to the electric field such that their long axes are perpendicular to a field direction.

The edges of the cutouts 91-95b and 71-75b of the field generating electrodes 191 and 270 and the edges of the pixel electrodes 191 distort the electric field to have a horizontal component that is substantially perpendicular to the edges of the cutouts 91-95b and 71-75b and the edges of the pixel electrodes 191.

Referring to FIG. 3, a set of the cutouts 71-75b and 91-95b divides a pixel electrode 191 into a plurality of sub-areas. Each sub-area has two primary edges making oblique angles with the perimeter edges of the pixel electrode 191. Therefore, a primary horizontal component of the electric field on each sub-area is perpendicular to the primary edges of the sub-area. Since most LC molecules 31 on each sub-area tilt on a plane perpendicular to the primary edges, the azimuthal distribution of the tilt directions are localized in four directions, thereby increasing a reference viewing angle of the LCD.

The interconnections denoted by reference character A may cause horizontal components that are oblique to the primary horizontal component, thereby causing textures and elongating the response time of the LC molecules 31. The interconnections overlap the oblique members, such as the storage electrodes 137, the gate lines 121, and optionally the light blocking member 220, and thus the textures can be covered with the oblique members. In addition, there are no interconnections in the areas denoted by reference character B (see FIG. 1), near the longitude portions of the shielding electrode 88, and thus there is no abnormal horizontal component in these areas.

Each of the longitudinal portions and the transverse portions of the cutouts 71-75b has two long edges E1 and E2, one edge E1 disposed on the pixel electrode 191 and the other edge E2 disposed outside of the pixel electrode 191. Furthermore, an edge E3 of the pixel electrode 191 is disposed between the edges E1 and E2 of the cutouts 71-75b. A horizontal component (referred to as “the first component” hereinafter) of the electric field generated by the edge E1 makes an acute angle with the primary horizontal component on the associated sub-area and is antiparallel to a horizontal component (referred to as “the second component” hereinafter) generated by the edge E3, which makes an obtuse angle with the primary component.

The second component is generated by, for example, a voltage difference between the pixel electrode 191 and the common electrode 270, a voltage difference between the pixel electrode 191 and the shielding electrode 270, and/or a voltage difference between the pixel electrode 191 and the data line 171 adjacent thereto. The voltage difference between the pixel electrode 191 and the common electrode 270 and the voltage difference between the pixel electrode 191 and the shielding electrode 88 may make the second component antiparallel to the first component.

The voltage difference between the pixel electrode 191 and the data line 171 is periodically varied since the data voltage carried by the data line 171 periodically reverses its polarity relative to the common voltage. When the polarity of the voltage of the pixel electrode 191 is opposite to the polarity of the data voltage of the data line 171, the second component is antiparallel to the first component and strong. Accordingly, if there is no shielding electrode, it is preferable that the edge E1 is disposed far from the edge E3 so that the LC molecules 31 on the sub-area may be subjected to a reduced effect of the second component. Since the shielding electrode 88 and the thick organic passivation layer 180 reduce the interference between the pixel electrode 191 and the data line 171 adjacent thereto, the distance D1 between the edges E1 and E3 can be reduced as compared with the case without shielding electrode.

The distance D1 between the edges E1 and E3 may be determined in view of the alignment margin between the TFT array panel 100 and the common electrode panel 200. For example, the distance D1 may be smaller than about 10 microns, and preferably equal to about 5-7 microns. The distance D2 between the edges E2 and E3 may be also equal to about 5-7 microns, and the longitudinal width of the cutout 71-75b, or the sum of the distances D1 and D2 is preferably equal to or smaller than about 11-13 microns.

The notches 7 in the cutouts 71-75b of the common electrode 270 determine the tilt directions of the LC molecules 31 on the cutouts 71-75b and they may be provided at the cutouts 91-95b of the pixel electrodes 191.

The shapes and the arrangements of the cutouts 71-75b and 91-95b and the notches 7 may be modified.

At least one of the cutouts 71-75b and 91-95b can be substituted with protrusions (not shown) or depressions (not shown). The protrusions are preferably made of organic or inorganic material and disposed on or under the field generating electrodes 191 or 270.

Since there is substantially no electric field between the shielding electrode 88 and the common electrode 270, the LC molecules 31 on the shielding electrode 88 remain in an initial orientation and thus the light incident thereon is blocked. Accordingly, the shielding electrode 88 may serve as a light blocking member.

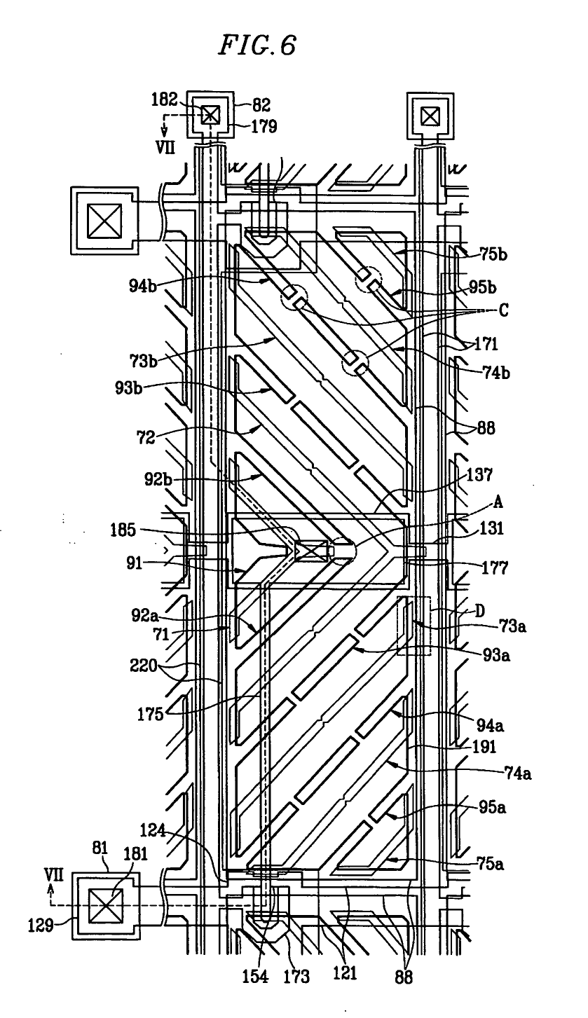

An LCD according to an embodiment of the present invention will be described in detail with reference to FIGS. 6, 7 and 8.

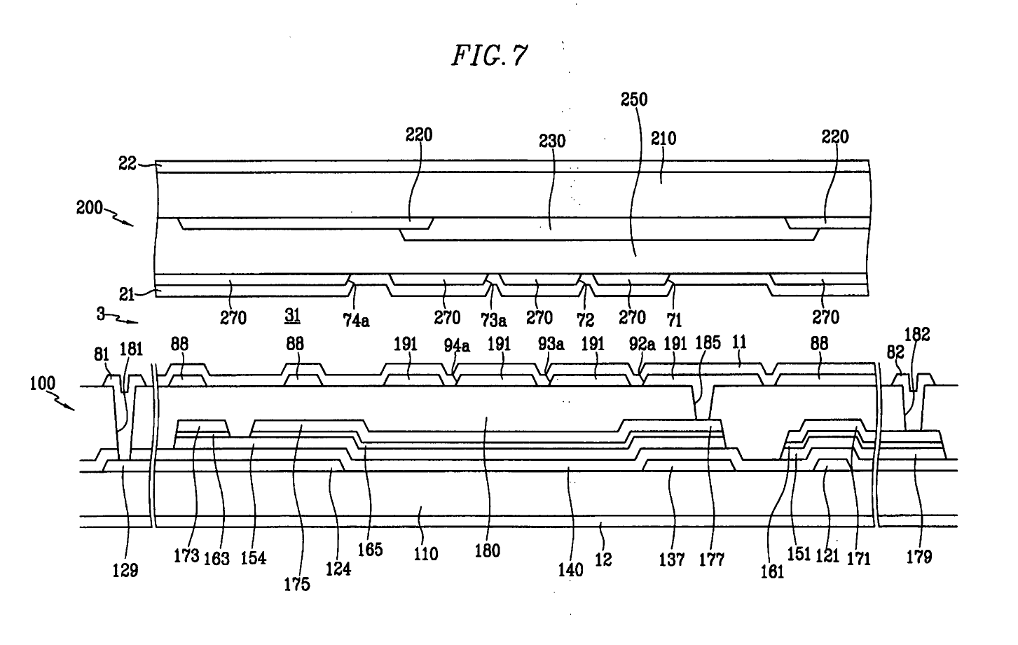

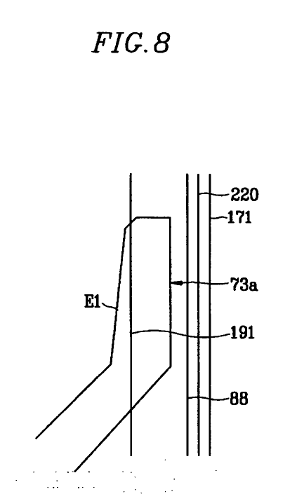

FIG. 6 is a layout view of an LCD according to an embodiment of the present invention, FIG. 7 is a sectional view of the LCD shown in FIG. 6 taken along line VII-VII′, and FIG. 8 is an expanded view of a portion of the LCD shown in FIG. 6.

Referring to FIGS. 6 and 7, an LCD includes a TFT array panel 100, a common electrode panel 200, a LC layer 3 interposed between the panels 100 and 200, and a pair of polarizers 12 and 22 attached on outer surfaces of the panels 100 and 200.

Layered structures of the panels 100 and 200 are substantially the same as those shown in FIGS. 1-5.

Regarding the TFT array panel 100, a plurality of gate lines 121, including gate electrodes 124 and end portions 129, and a plurality of storage electrode lines 131, including storage electrodes 137, are formed on a substrate 110, and a gate insulating layer 140, a plurality of semiconductors 154, and a plurality of ohmic contacts 163 and 165 are sequentially formed thereon. A plurality of data lines 171, including source electrodes 173 and end portions 179, and a plurality of drain electrodes 175, including expansions 177, are formed on the ohmic contacts 163 and 165. A passivation layer 180 is formed on the data lines 171 and the drain electrodes 175. A plurality of contact holes 181, 182 and 185 are provided through the passivation layer 180. Contact hole 181 is further provided through the gate insulating layer 140. A plurality of pixel electrodes 191 including a plurality of partitions divided by cutouts 91-95b, a shielding electrode 88 having a plurality of apertures 881, and a plurality of contact assistants 81 and 82 are formed on the passivation layer 180, and an alignment layer 11 is coated thereon.

Regarding the common electrode panel 200, a light blocking member 220, a plurality of color filters 230, an overcoat 250, a common electrode 270 having a plurality of cutouts 71-75b, and an alignment layer 21 are formed on an insulating substrate 210 facing the TFT array panel 100.

Different from the LCD shown in FIGS. 1-5, the partitions of each of the pixel electrodes 191 are connected by the interconnections denoted by reference character C in FIG. 6, which are disposed away from the edges of the pixel electrode 191. The number of the interconnections is preferably minimized for reducing the distortion of the electric field on each sub-area.

In addition, an edge E1 of a longitudinal portion of each of the cutouts 71-75b, which overlaps a pixel electrode 191, is oblique to a longitudinal edge of the pixel electrode 191 as shown in FIG. 8 illustrating an expanded view of a portion D shown in FIG. 6. The edge E1 makes an angle larger than about 135 degrees with an oblique portion of the cutout 71-75b connected to the longitudinal portion. This configuration makes the horizontal component of the electric field on each sub-area close to the primary horizontal component.

Furthermore, the semiconductors 154 and the ohmic contacts 163 of the TFT array panel 100 according to an embodiment of the present invention extend along the data lines 171 to form semiconductor islands 151 and ohmic contact islands 161. In addition, the semiconductors 154 have substantially the same planar shapes as the data lines 171 and the drain electrodes 175 as well as the underlying ohmic contacts 163 and 165. The semiconductors 154 include some exposed portions, which are not covered with the data lines 171 and the drain electrodes 175, such as portions located between the source electrodes 173 and the drain electrodes 175.

A manufacturing method of the TFT array panel according to an embodiment of the present invention simultaneously forms the data lines 171 and the drain electrodes 175, the semiconductor islands 151, and the ohmic contacts 161 and 165 using one photolithography step.

A photoresist masking pattern for the photolithography process has position-dependent thickness, and in particular, it has first and second portions with decreased thickness. The first portions are located on wire areas that will be occupied by the data lines 171, the drain electrodes 175, and the metal pieces 172, and the second portions are located on channel areas of TFTs.

The position-dependent thickness of the photoresist is obtained by several techniques, for example, by providing translucent areas on the exposure mask as well as transparent areas and light blocking opaque areas. The translucent areas may have a slit pattern, a lattice pattern, or a thin film(s) with intermediate transmittance or intermediate thickness. When using a slit pattern, it is preferable that the width of the slits or the distance between the slits is smaller than the resolution of a light exposer used for the photolithography. Another example is to use a reflowable photoresist. In detail, once a photoresist pattern made of a reflowable material is formed by using an exposure mask with transparent areas and opaque areas, it is subjected to a reflow process to flow onto areas without the photoresist, thereby forming thin portions.

As a result, the manufacturing process is simplified by omitting a photolithography step.

Many of the above-described features of the LCD shown in FIGS. 1-5 may be applied to the LCD shown in FIGS. 6-8.

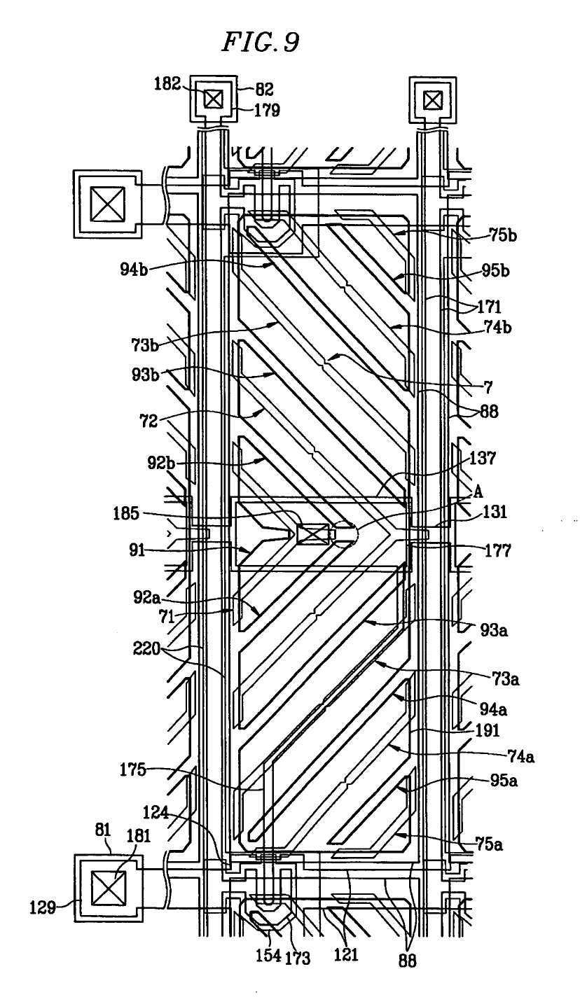

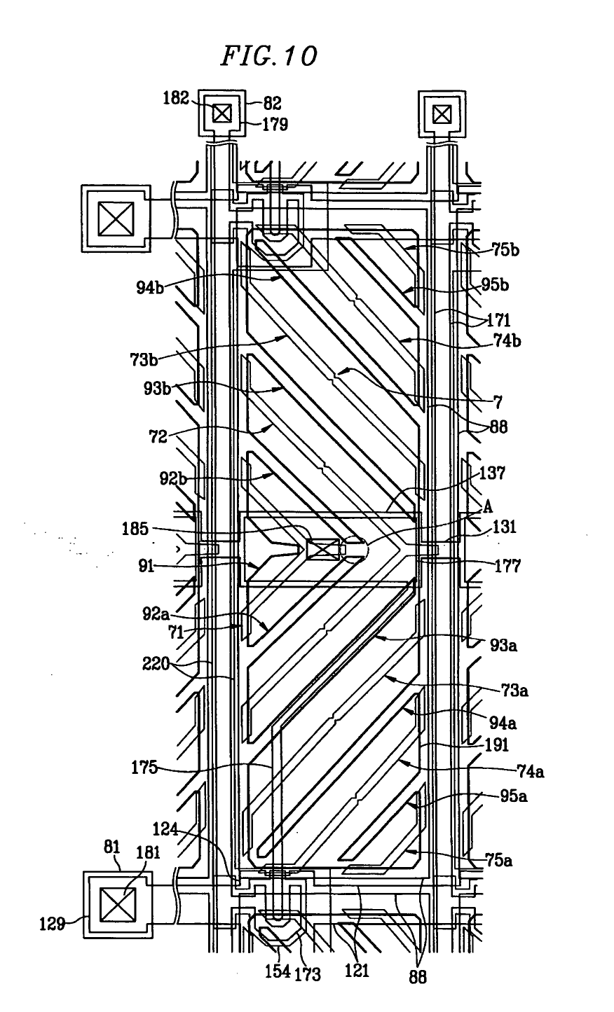

An LCD according to an embodiment of the present invention will be described in detail with reference to FIGS. 9 and 10.

FIGS. 9 and 10 are layout views of LCDs according to an embodiment of the present invention.

The LCDs shown in FIGS. 9 and 10 have substantially the sectional views shown in FIGS. 4 and 5.

Referring to FIGS. 9 and 10 as well as 4 and 5, an LCD according to an embodiment of the present invention includes a TFT array panel 100, a common electrode panel 200, a LC layer 3 interposed between the panels 100 and 200, and a pair of polarizers 12 and 22 attached on outer surfaces of the panels 100 and 200.

Layered structures of the panels 100 and 200 are substantially the same as those shown in FIGS. 1-5.

Regarding the TFT array panel 100, a plurality of gate lines 121, including gate electrodes 124 and end portions 129, and a plurality of storage electrode lines 131 including storage electrodes 137 are formed on a substrate 110. A gate insulating layer 140, a plurality of semiconductors islands 154, and a plurality of ohmic contacts 163 and 165 are sequentially formed thereon. A plurality of data lines 171 including source electrodes 173 and end portions 179, and a plurality of drain electrodes 175 including expansions 177 are formed on the ohmic contacts 163 and 165 and the gate insulating layer 140, and a passivation layer 180 is formed thereon. A plurality of contact holes 181, 182 and 185 are provided through the passivation layer 180. Contact hole 181 is further provided through the gate insulating layer 140. A plurality of pixel electrodes 191 including a plurality of partitions divided by cutouts 91-95b, a shielding electrode 88 having a plurality of apertures 181, 182 and 185, and a plurality of contact assistants 81 and 82 are formed on the passivation layer 180, and an alignment layer 11 is coated thereon.

Regarding the common electrode panel 200, a light blocking member 220, a plurality of color filters 230, an overcoat 250, a common electrode 270 having a plurality of cutouts 71-75b, and an alignment layer 21 are formed on a surface of an insulating substrate 210 facing the TFT array panel 100.

Different from the LCD shown in FIGS. 1-5, each of the drain electrodes 175 extends along the cutouts 71-75b and 91-95b to increase the aperture ratio. The LCD shown in FIG. 10 may have an aperture ratio larger than the LCD shown in FIG. 9 since the possibility of misalignment between two panels 100 and 200 is higher than the possibility of misalignment of the layers in a panel 100. In the LCD shown in FIG. 10, increasing the thickness of the organic passivation layer 180 may reduce the primary horizontal field caused by the alignment of the drain electrodes 175 with the cutouts 92a-95b.

Many of the above-described features of the LCD shown in FIGS. 1-5 may be applied to the LCDs shown in FIGS. 9 and 10.

Although preferred embodiments of the present invention have been described in detail hereinabove, it should be clearly understood that many variations and/or modifications of the inventive concepts herein taught, which may appear to those skilled in the present art, will fall within the spirit and scope of the present invention.

What is claimed is:

1. A liquid crystal display panel comprising:
a substrate; and
a pixel electrode disposed on the substrate, the pixel electrode having a plurality of cutouts extending at one or more oblique angles to edges of the pixel electrode,
wherein the cutouts divide the pixel electrode into a plurality of partitions, wherein the adjacent partitions are connected to each other by a respective one of a plurality of interconnections, and the plurality of interconnections are spaced apart from a perimeter edge of the pixel electrode.

2. The liquid crystal display panel of claim 1, further comprising:
a thin film transistor coupled to the pixel electrode;
a gate line coupled to the thin film transistor; and
a data line coupled to the thin film transistor.

3. The liquid crystal display panel of claim 2, further comprising:
an insulating layer disposed on the thin film transistor, the gate line, and the data line and disposed under the pixel electrode; and
a shielding electrode disposed on the insulating layer, overlapping the data line, and spaced apart from the pixel electrode.

4. The liquid crystal display panel of claim 3, wherein the insulating layer comprises an organic material.

5. A liquid crystal display panel comprising:
a substrate;
an opaque member disposed on the substrate; and
a pixel electrode disposed on the substrate, insulated from the opaque member, overlapping the opaque member, and having a cutout that extends at an oblique angle to an edge of the pixel electrode,
wherein the cutout divides the pixel electrode into a plurality of partitions, wherein the plurality of partitions are connected to each other by an interconnection, and the interconnection is disposed substantially on a perimeter edge of the pixel electrode, proximate to the opaque member.

6. The liquid crystal display panel of claim 5, further comprising:
a thin film transistor including a drain electrode coupled to the pixel electrode;
a gate line coupled to the thin film transistor; and
a data line coupled to the thin film transistor.

7. The liquid crystal display panel of claim 6, wherein the opaque member comprises at least one of a portion of the gate line and/or a portion of the drain electrode.

8. The liquid crystal display panel of claim 6, wherein the opaque member is a storage electrode overlapping the drain electrode.

9. The liquid crystal display panel of claim 6, further comprising:
an insulating layer disposed on the opaque member and the data line and disposed under the pixel electrode; and
a shielding electrode disposed on the insulating layer, overlapping the data line, and spaced apart from the pixel electrode.

10. The liquid crystal display panel of claim 9, wherein the insulating layer comprises an organic material.

11. A liquid crystal display panel comprising:
a substrate;
a thin film transistor disposed on the substrate;
a gate line coupled to the thin film transistor;
a data line coupled to the thin film transistor;
an insulating layer disposed on the thin film transistor, the gate line, and the data line;
a pixel electrode disposed on the insulating layer and coupled to the thin film transistor; and
a shielding electrode disposed on the insulating layer, overlapping the data line, and spaced apart from the pixel electrode by a distance equal to or greater than about seven microns.

12. The liquid crystal display panel of claim 11, wherein the insulating layer comprises an organic material.

13. The liquid crystal display panel of claim 11,
wherein the pixel electrode includes a plurality of first cutouts extending at an oblique angle to an edge of the pixel electrode, the liquid crystal display panel further comprising:
a second substrate facing the first substrate; and
a common electrode disposed on the second substrate and having a plurality of second cutouts arranged alternately between the first cutouts,
wherein at least one of the second cutouts has a first portion substantially parallel to the first cutouts and a second portion connected to the first portion and making an obtuse angle with the first portion, the second portion having a first edge overlapping the pixel electrode and a second edge disposed opposite the first edge with respect to a perimeter edge of the pixel electrode, and the distance between the first edge of the second portion and the perimeter edge of the pixel electrode is equal to from about five microns to about seven microns.

14. A liquid crystal display comprising:
a first substrate;
a pixel electrode disposed on the first substrate, the pixel electrode having a first cutout extending at an oblique angle to a perimeter edge of the pixel electrode;
a second substrate facing the first substrate;
a common electrode disposed on the second substrate and having a second cutout arranged adjacent to the first cutout;
an opaque member disposed on one of the first or the second substrates; and
a liquid crystal layer disposed between the pixel electrode and the common electrode,
wherein the first cutout divides the pixel electrode into a plurality of partitions, the plurality of partitions are connected to each other by an interconnection, and the interconnection is spaced apart from a perimeter edge of the pixel electrode or disposed on or under the opaque member.

15. The liquid crystal display of claim 14, further comprising:
a thin film transistor including a drain electrode coupled to the pixel electrode;
a gate line coupled to the thin film transistor;
a data line coupled to the thin film transistor; and
a storage electrode overlapping the drain electrode.

16. The liquid crystal display of claim 15, wherein the opaque member comprises at least one of a portion of the gate line, a portion of the drain electrode or a portion of the storage electrode.

17. The liquid crystal display of claim 15, wherein the opaque member comprises a light blocking member disposed around the pixel electrode.

18. The liquid crystal display panel of claim 15, further comprising:
an insulating layer disposed on the thin film transistor, the gate line, the data line, and the storage electrode, and disposed under the pixel electrode; and
a shielding electrode disposed on the insulating layer, overlapping the data line, and spaced apart from the pixel electrode.

19. The liquid crystal display of claim 15, wherein the drain electrode extends along one of the first or the second cutouts.

20. The liquid crystal display of claim 15, wherein the second cutout has a first portion substantially parallel to the first cutout and a second portion connected to the first portion and making an obtuse angle greater than about 135 degrees with the first portion, the second portion having a first edge overlapping the pixel electrode and a second edge disposed opposite the first edge with respect to an edge of the pixel electrode.
